(19) United States
(12) Patent Application Publication
(10) Pub. No.: US 2007/0293191 A1
(43) Pub. Date: Dec. 20, 2007

(54) Pre-paid security mechanism in a post-pay telecommunications system

(76) Inventors: Amanullah Mir, Newton, PA (US); Alan Hopson, Oceanport, NJ (US); Grace Im, North Brunswick, NJ (US); Daivd Heyrich, Wahsington, NJ (US); Hema Bhavsar, North Brunswick, NJ (US); Lori McGrail, La Vergne, TN (US)

Correspondence Address: TELCORDIA TECHNOLOGIES, INC., ONE TELCORDIA DRIVE 5G116, PISCATAWAY, NJ, 08854-4157, US

(21) Appl. No.: 11/805,781

(22) Filed: May 24, 2007

Related U.S. Application Data
(60) Provisional application No. 60/808,995, filed on May 26, 2006.

(51) Int. Cl. H04M 11/00

(52) U.S. Cl. 455/406

(57) ABSTRACT

The present invention provides a method and system for real-time charging including the following capabilities: calculation and storage of real time usage information on a per subscriber or group basis; real-time criteria evaluation of configurable thresholds; real-time threshold notification to the subscriber/account owner; and subscriber/account owner interaction capability to restrict specific calls and events for any member of a group, through external systems, text messaging and interactive voice response (IVR) sessions. When these four major capabilities are combined and configured, a pre-paid functionality in a post pay environment is produced.

### CROSS REFERENCE TO RELATED APPLICATION

The present invention claims the benefit of U.S. provisional patent application 60/808,995 filed May 26, 2006, the entire content and disclosure of which is incorporated herein by reference.

### FIELD OF THE INVENTION

The present invention relates generally to the field of wireless and wireline telecommunications networks and specifically to the creation and implementation of services for charging subscribers for usage of such networks.

### BACKGROUND OF THE INVENTION

Presently, wireless and wireline telecommunications networks throughout the globe offer post-paid network usage services by storing the total amount of usage accumulated by a subscriber within a defined period of time, usually monthly. The subscriber is billed a fixed fee for a defined amount of usage, e.g. $20 for 700 minutes, and charged a rate on the usage over the limit, e.g. 40 cents per minute. Group/Family accounts share the usage, which is usually paid monthly, and are charged extra for usage over the defined limit. A typical family account could include a subscriber and one or more other users, each having his own ID code, while a group account could have more than one ID code for the same subscriber.

Pre-paid services are also known in the art. For example, U.S. Pat. No. 5,722,067 discloses a cellular telecommunications system that permits access by pre-paid users. A user enters an automated number identification code (ANI) and a dialed number identification system code (DNIS) into the system. First, the ANI is validated, and then account balance information for the user is queried to determine if there is a positive credit balance. If so, the call can proceed. Whenever a timer event, such as the elapse of a predetermined time period, occurs, the account balance is decreased. The account balance is not evaluated in real time but only upon termination of service, e.g. at disconnect or on-hook, or at the end of a fixed time period.

U.S. Pat. No. 5,353,335 discloses a pre-paid service implemented in a system on a fixed telecommunications network. The disclosed system checks for sufficient credit, that is, dollar amount or account balance, and terminates service if credit is depleted. However, neither of these patents disclose dynamic or real time control of usage. Moreover, no services for families or groups of subscribers are available. Hence, no sharing of account balances among subscribers is permitted. Each account has only one owner or subscriber. Consequently, an account balance can only be changed by the service provider, upon instruction from the ANI owner or service subscriber.

One problem with present techniques is that there is no real time alerting mechanism to notify the subscriber or account holder when an account balance is depleted. Another problem is the lack of a restriction mechanism activated through user interaction. Yet another problem is the inability to share account balances among a group of subscribers or account holders of pre-paid services, such as within a family or a business entity.

### BRIEF SUMMARY OF THE INVENTION

This invention solves the above problems with a telecommunications network real-time charging service (RCS) that calculates and stores real time usage information on a per subscriber or group basis, checks defined limits in real time against the real time usage data, offers various avenues of notification or alerting to any designated individual, such as a subscriber or an account owner, and provides mechanisms to restrict the use of an account through interaction with the designated individual. As illustrated above, the prime purpose of a pre-paid service is to stop call activity or system usage when credit is exhausted, enabling the institution of budgeted use. RCS achieves this purpose by notifying the subscriber or account holder of the amount of service being used, and providing him the ability to stop further use, except for special incoming calls and outgoing emergency calls, if desired. Thus the inventive RCS offers pre-paid functionality in a post-paid environment.

Accordingly, the invention provides a system and method for real-time charging for service usage in a telecommunications system, including receiving a service request from a subscriber, and validating the subscriber within the system. Once a subscriber is validated, his subscriber information is obtained; this information includes one or more designated individuals or notification recipient, as well as subscriber threshold data or values. After this information is obtained, the requested service is commenced and real-time usage data is tracked. If the real-time usage data exceeds the subscriber threshold data, the notification recipient is notified. The RCS system includes a subscriber database having at least notification recipient data and subscriber threshold data and a host device which can receive a service request from the subscriber and validate the subscriber. The system also includes real-time usage data and a criteria checking mechanism for notifying the notification recipient if the real-time usage data exceeds the subscriber threshold data.

The foregoing and other objects, aspects, features, advantages of the invention will become more apparent from the following description and from the claims.

### BRIEF DESCRIPTION OF THE DRAWINGS

The invention is further described in the detailed description that follows, by reference to the noted drawings by way of non-limiting illustrative embodiments of the invention, in which like reference numerals represent similar parts throughout the drawings. As should be understood, however, the invention is not limited to the precise arrangements and instrumentalities shown. In the drawings:

FIG. 1 is a block diagram of a telecommunications network in which an exemplary embodiment of the present invention can be installed;

FIG. 2 is a flow diagram illustrating the steps of the validation portion in one embodiment of the present invention;

FIG. 3 is a flow diagram illustrating the steps of the call processing portion in one embodiment of the present invention;

FIG. 4 is a flow diagram illustrating the steps of the notification portion in one embodiment of the present invention; and

FIG. 5 is a flow diagram illustrating the steps of the restriction portion in one embodiment of the present invention.

### DETAILED DESCRIPTION

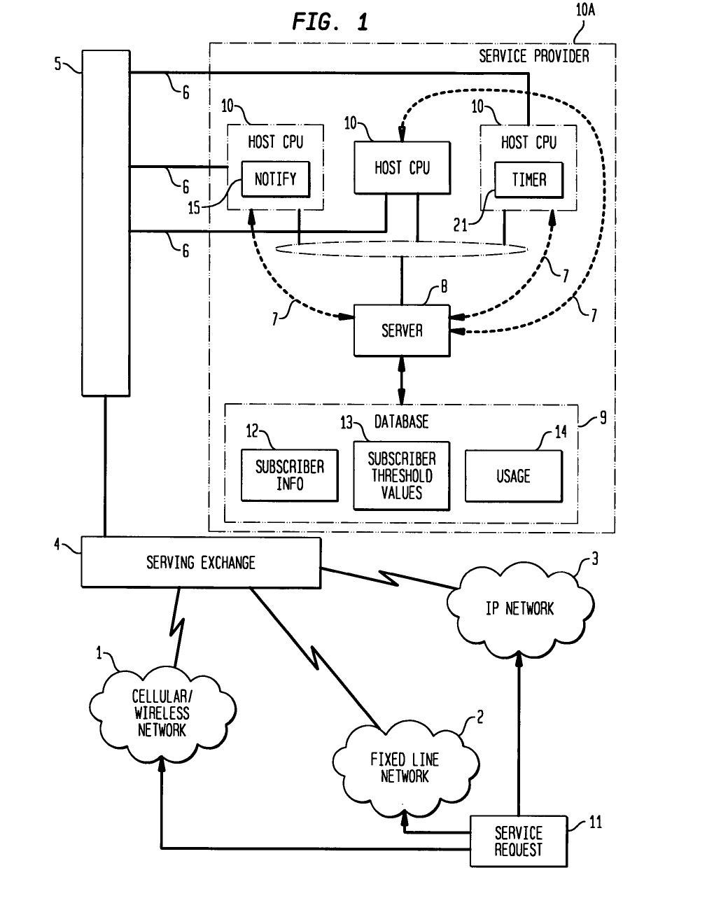

An inventive solution to the need for a real-time charging system (RCS) is presented. FIG. 1 shows a telecommunications network having an RCS. A service provider's system 10A is connected to a serving exchange 4 via network connections 5,6, the connection depending, among other things, on the network type to which the system is connected. For example, the network connections can be T1, E1, LAN or WAN. The service provider's system 10A contains a set of host CPUs 10 which, in a preferred embodiment, are each built with a micro processing unit having a fast clock speed, i.e. 32 or 64 bit processors. In one embodiment, the host CPU has a timer 21. Each host CPU 10 is equipped with a number of network interface cards for bi-directional communication, that is, transmitting information between the host CPU 10 and the serving exchange 4 through the network connections 5,6, and also between the host CPU 10 and the service provider's server 8 through a networked LAN/WAN connection 7. This architecture of host CPUs 10 with a networked server 8 allows more than one service provider (not shown) to operate within the connected telecommunications networks 1,2,3 in a distributed fashion.

Further, server 8 has a database 9 that holds the subscriber information 12 used to record the value of usage service information or usage 14 as well as subscriber preferences or subscriber threshold values 13. Within the database 9, in a preferred embodiment, each subscriber is identified with an ANI. A subscriber identifier could also be a Mobile Station Integrated Service Digital Network (MSISDN), a Mobile Identification Number (MIN), an International Mobile Subscriber Identity (IMSI), or another single identifying piece of data, e.g. subscriber ID. In one embodiment, the service requested by the subscriber is identified by the DNIS, which is also known as the terminating subscriber ID, the called party number, or short code.

The serving exchange 4 connects the service provider 10A to a cellular/wireless network 1, a fixed line network 2, and an IP network 3 via network connections or landline links 5, 6. The serving exchange carrier could be, for example, circuit switched or packet switched, but any such switch could be employed. These networks 1, 2, 3 communicate information on calls and/or events for subscribers registered with the given service provider 10A.

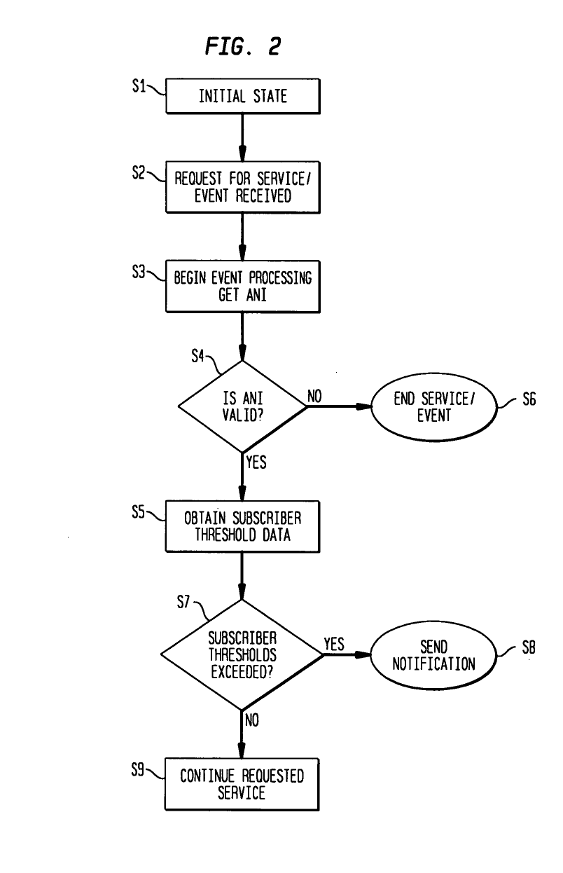

The flow of the validation portion of the RCS in one embodiment of the invention is illustrated in FIG. 2 with the network of FIG. 1. At step S1, host CPU 10 is in an initial state. A subscriber initiates the transmission of a telecommunications communication message or service request 11 from a network 1,2,3 through the serving exchange 4 to the host CPU 10. The service request 11 initiates an event and contains subscriber identification, such as ANI, instructions, such as DNIS, and a variety of operations, which can only be restricted by the capabilities of current end user devices.

Upon receipt of the service request or service indication message 11 at step S2, the host CPU 10 processes the event in the request 11. This processing entails reading, analysis and storage of the information in the service request 11, as follows. At step S3, the ANI is retrieved from the incoming service indication message 11. The database 9 is searched to determine at step S4 whether the ANI received is valid for this service provider 10A. If the ANI is valid (S4=YES), the subscriber information 12 and subscriber threshold data 13 is obtained at step S5. If the incoming ANI is not found in the service provider database 9 (S4=NO), the requested service 11 is terminated at step S6 by the service provider 10A, and termination is communicated via the network communication lines 5,6 to the serving exchange 4 which passes the message to the requesting network 1, 2, 3. The treatment of the termination indication, that is, the actions taken in response to the termination indication, can be conducted at the service provider 10A or the serving exchange 4.

Once the subscriber information 12 and subscriber threshold data 13 is obtained at step S5, these subscriber defined usage threshold criteria 13 are checked, at step S7, against current usage 14 which is also held in the database 9. If any of these subscriber threshold values 13 are crossed or exceeded (S7=YES), the service provider 10A will send a notification event 15 at step S8 to the subscriber's registered notification party or notification recipient. Notifications 15 are communicated to the notification party via the network communication lines 5,6 to the serving exchange 4. Communication can be made not only through the serving exchange 4 but can also be made via a networked LAN/WAN connection to a secondary access machine (not shown), depending on the notification type selected by the service provider 10A.

Once subscriber threshold values 13 are checked at step S7 and, if necessary, notifications 15 have been sent at step S8, the service provider 10A will send a continue event at step S9 to the originating network 1,2,3 via the serving exchange 4 so the connection to the desired service can be made and the requested service event can commence.

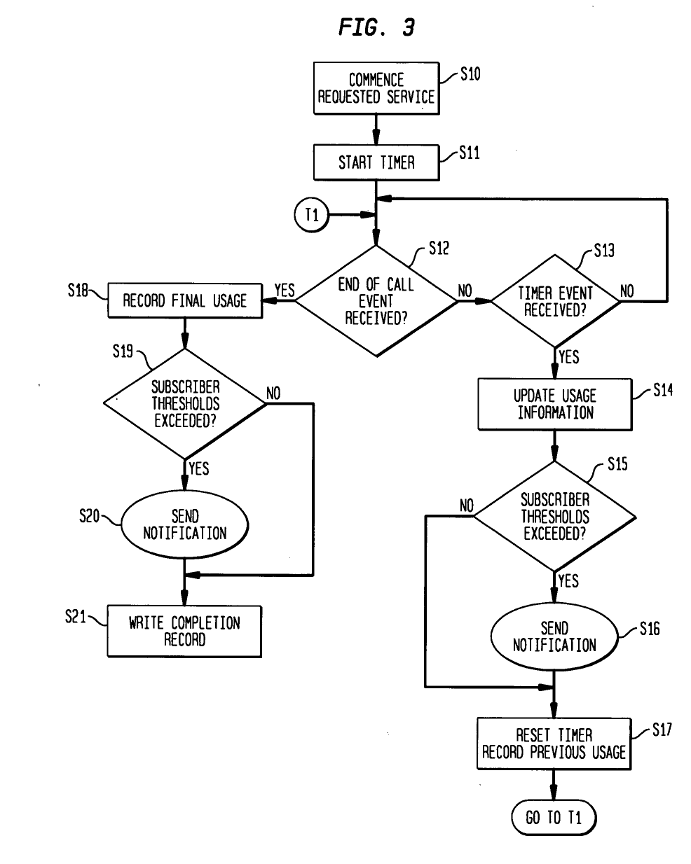

FIG. 3 illustrates the flow of the call processing portion of the RCS in one embodiment of the invention, using the network of FIG. 1. Upon establishing a connection to the receiving or terminating service, for example, the service on which the DNIS resides, the network 1,2,3 sends a connection event to the service provider 10A via the serving exchange 4 which is processed on the service provider CPU 10. Hence, at step S10, the requested service commences, and a timer mechanism is started at step S11. The timer mechanism could be a timer 21 on the service provider CPU 10 or a timer message 21 to the serving exchange 4.

Once the timer 21 has been set or initialized at step S11, one of two major events is expected, an end of call event from the subscriber/terminating service, or a timer event. The system first checks for an end of call event at step S12 and, if it has not been received (S12=NO), the system checks for a timer event at step S13. Either of the events could be communicated from the originating network 1,2,3 via the serving exchange 4. The end of call event is described below.

If a timer event is received (S13=YES), the service provider CPU 10 calculates the value of service usage 14 accumulated during the time period at step S14. This usage 14 could be a unit of time or a unit of quantity depending on the service requested by the subscriber. The usage 14 for the subscriber within the duration of the timer 21 is recorded in the service provider database 9.

The service provider 10A includes a criteria checking mechanism which operates as follows. The criteria checking mechanism examines the thresholds or subscriber threshold data 13 recorded in the database 9 and checks to see if the subscriber has reached any of the threshold values 13 at step S15. When a threshold is crossed or exceeded (S15=YES), a notification 15 is sent at step S16 from the service provider CPU 10 to a notification recipient or set of recipients listed in the subscriber information 12 in the database 9. The notification 15 is communicated to the serving exchange 4 via network connections 5, 6 or to other external systems via the networked LAN/WAN connection (not shown). The notification as well as the transport mechanism of the notification are configured and recorded as part of the subscriber information 12 in the service provider database 9. The transport mechanism can include communication using mobile or cellular telephones as well as traditional landline telephones, text messages, e-mail messages, interactive voice response (IVR), and other such mechanisms known in the art. The notification process is further described below.

Next, the timer event is reset and the usage 14 for the previous duration is recorded at step S17, whether or not any notifications 15 of threshold crossings (S15=YES) have been sent at step S16. The subscriber continues to utilize his requested service 11, and the system 10A continues to operate the timer event in the manner described above and to test for an end of call or end of service event at step S12 from the network 1, 2, 3 via the serving exchange 4. The end of call event indicates successful completion of the service request 11. Upon receipt of this end of service instruction (S12=YES), the final usage is calculated and stored in the database 9 at step S18, threshold values 13 are checked at step S19 and, if thresholds are crossed (S19=YES), notification is sent at step S20. Further, a completion record is written at step S21.

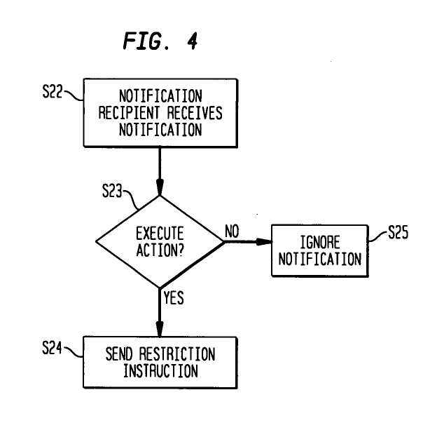

The flow of the notification process of the RCS in one embodiment of the invention is illustrated in FIG. 4 using the network of FIG. 1. Upon receipt of a notification message 15 at step S22 from the service provider CPU 10, the receiver of the notification, that is, a notification recipient or set of recipients listed in the subscriber information 12, can decide at step S23 whether to execute another action. If another action is to be executed (S23=YES), the action can include, for example, send a restriction event at step S24. In the alternative (S23=NO), the notification of the crossing of the threshold 13 can be ignored at step S25. The restriction event can be sent from an end user telecommunication device or an internet connected device, or other such devices as are known in the art; the restriction event is received from a network 1, 2, 3 or via a serving exchange 4 or via a networked LAN/WAN connection (not shown).

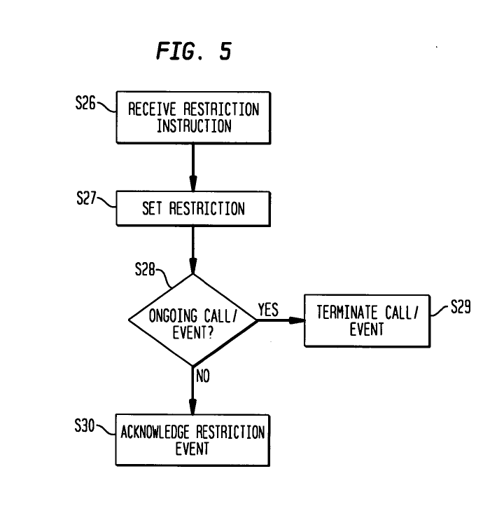

FIG. 5 illustrates the flow when a restriction event occurs using the network shown in FIG. 1. Upon receipt of a restriction event at step S26, the relevant restriction indicators are set at step S27 for the designated subscriber. The restriction indicators are stored in the subscriber information 12 in the service provider's database 9 until either an un-restrict event is received by the system, or a period of time set by the service provider 10A has passed.

If a subscriber for which the restriction event was received is in an ongoing service interaction at step S28 and the restriction was for that service, a termination event is sent at step S29 to the serving exchange 4 via a network connection 5,6 destined for the originating network 1, 2, 3. Otherwise, the restriction event is acknowledged at step S30 and processing continues.

The present invention offers a number of capabilities: calculation and storage of real time usage information on a per subscriber or group basis; real-time criteria evaluation of configurable thresholds; real-time threshold notification to the subscriber/account owner; and user interaction capability to restrict specific calls and events for any member of a group, through external systems, text messaging and interactive voice response sessions. These four major capabilities, when combined and configured, produce a pre-paid like functionality in a post pay environment.

While the present invention has been described in particular embodiments, it should be appreciated that the present invention should not be construed as limited by such embodiments, but rather construed according to the below claims.

What is claimed is:

1. A method for real-time charging for service usage in a telecommunications system having at least one subscriber, said method comprising:
receiving a service request from the subscriber;
validating the subscriber and obtaining notification recipient data and subscriber threshold data;
commencing the requested service and tracking real-time usage data; and
notifying the notification recipient data if the real-time usage data exceeds the subscriber threshold data.

2. The method according to claim 1, wherein the notification recipient data indicates one of execute an action, ignore the notification, terminate the requested service and cancel the requested service.

3. The method according to claim 2, wherein the action is send a restriction event.

4. The method according to claim 1, wherein the subscriber is the notification recipient data.

5. The method according to claim 1, wherein notifying is performed using at least one of mobile telephones, cellular telephones, landline telephones, text messages, e-mail messages, and interactive voice response.

6. A real-time charging system for use in a telecommunications system having at least one subscriber, comprising:
a subscriber database comprising at least notification recipient data and subscriber threshold data;
a host device operable to receive a service request from the subscriber, and validate the subscriber;
real-time usage data; and
a criteria checking mechanism operable to notify the notification recipient data if the real-time usage data exceeds the subscriber threshold data.

7. The system according to claim 6, wherein the notification recipient data indicates one of execute an action, ignore the notification, terminate the requested service, and cancel the requested service.

8. The system according to claim 7, wherein the action is send a restriction event.

9. The system according to claim 6, wherein the subscriber is the notification recipient.

10. The system according to claim 6, wherein the host device is a CPU.

11. The system according to claim 6, wherein a database includes the subscriber, the notification recipient and the subscriber threshold data.

12. The system according to claim 6, wherein notifying is performed using at least one of mobile telephones, cellular telephones, landline telephones, text messages, e-mail messages, and interactive voice response.

13. A computer readable medium having computer readable program for operating on a computer for executing a real-time charging system, said program comprising instructions that causes the computer to perform the steps of:
receiving a service request from a subscriber;
validating the subscriber and obtaining notification recipient data and subscriber threshold data;
commencing the requested service and tracking real-time usage data; and
notifying the notification recipient data if the real-time usage data exceeds the subscriber threshold data.

14. The program according to claim 13, wherein the notification recipient data indicates one of execute an action, ignore the notification, terminate the requested service and cancel the requested service.

15. The program according to claim 14, wherein the action is send a restriction event.

16. The program according to claim 13, wherein the subscriber is the notification recipient data.

17. The program according to claim 13, wherein notifying is performed using at least one of mobile telephones, cellular telephones, landline telephones, text messages, e-mail messages, and interactive voice response.
